(19) United States
(12) Patent Application Publication
(10) Pub. No.: US 2008/0262831 A1
(43) Pub. Date: Oct. 23, 2008

(54) Method for the Natural Language Recognition of Numbers

(76) Inventor: Klaus Dieter Liedtke, Nienburg (DE)

Correspondence Address: THE MAXHAM FIRM, 9330 SCRANTON ROAD, SUITE 350, SAN DIEGO, CA, 92121, US

(21) Appl. No.: 11/629,551

(22) PCT Filed: Jun. 13, 2005
(86) PCT No.: PCT/EP05/06297

§ 371 Date: Nov. 26, 2007

(30) Foreign Application Priority Data
Jun. 14, 2004 (DE) 10 2004 028 724.4

(51) Int. Cl. G06F 17/27; G10L 15/00

(52) U.S. Cl. 704/9; 704/251; 704/E15.001

(57) ABSTRACT

A method for the natural language recognition of numbers, in particular, for use in a voice recognition system. The recognition method is as the follows: a spoken numeral is detected and digitized, the numeral is broken down into number-related word components, the mutual position of the word components is determined within the numeral, the numerical values corresponding to the word components are compared and recognized using word component-number value pairs maintained in a digital dictionary, and the individual numerical values are strung together and/or added and/or multiplied according to the type and positions thereof of the corresponding word components in the numeral such that the numerical value corresponding to the input numeral is obtained.

### FIELD OF THE INVENTION

The invention relates to a method for the natural-language recognition of numbers, in particular for use in a voice recognition system.

### DISCUSSION OF PRIOR ART

Voice recognition systems are used in many telecommunications applications, for example, for recognizing a telephone number spoken by a user and making it usable for further processing. Many of these voice recognition systems support a natural pronunciation of numbers. When a user wants to enter the number “348”, for example, he speaks it as one continuous word “three hundred forty-eight” into the system. This natural-language input, however, quite frequently results in recognition errors, so that the user must speak the number to entered “348” again as the continuous single-digit numerals “three” “four” “eight” for the system to detect it clearly.

It has been demonstrated that the existing systems used for number recognition are suited only to a limited extent for the future requirements associated with natural-language applications. The existing grammar modules for number recognition, for example, at over 300 subgrammatics, have generally turned out to be too sluggish and only conditionally suitable for practical use.

Within the framework of familiarizing users with voice recognition systems, ever increasing demands become apparent: Telephone numbers are increasingly not expressed as individual digits any more, but in arbitrary digit combinations, for example “zero five hundred eleven” instead of “zero five one one.” This is where conventional number detection systems meet their limits, for one, due to their size, and secondly, due to their limitation when it comes to detecting three-digit or a maximum of four-digit number combinations.

The machine-based detection of numbers creates two basic problems for number recognition:
First, the presently widely used grammatics for number detection are based on the decimal system and reconstruct spoken series of numbers based on arithmetic logic. This—particularly in the German language—does not correspond to the spoken language, which can be illustrated well with the example of the so-called “inversion often.” For example, the number “21” in German is not spoken in line with the writing as “twenty-one,” but instead in reversed (inverted) sequence as “one and twenty.” Within the arithmetic logic of the decimal system, the depiction of natural-language numbers formation requires significant efforts, which so far have only been accomplished by employing a very large number of subgrammatics.
Secondly, natural-language number sequences are frequently ambiguous: “one hundred forty” may mean “140,” but also “100 40.” A differentiation between the two alternatives is only possible based on the pause between “one hundred” and “forty.” In the case of number sequences with limited length or with limited latitude, such as telephone numbers including area codes, the grammar is typically in a position to determine which of the potentially equivalent alternatives must be the correct one because, for example, the overall length of the stated number otherwise would be either too short or too long. If such a possibility for plausibility analysis of the detected number is lacking, problems arise, which so far have not been resolved satisfactorily.

US Patent application publication 2002 042709 A1 describes a solution for providing a better machine-based understanding of spoken sequences of numbers. The underlying problem here is that these number sequences may be understood differently, depending on whether, for example, five hundred thirty is understood as 5-100-30 or 500-30 or as 530. To solve this problem, a recognition method is proposed, which is based on determining the pause length between the numbers.

U.S. Pat. No. 6,513,002 B1 reveals a method for translating alphabetical number input into numerical number sequences and vice versa. The method expressly relates to written text input and output and does not taken the spoken language into consideration.

### SUMMARY OF THE INVENTION

It is therefore a purpose of the present invention to create a method for the natural-language recognition of numbers, which detects spoken numbers with great accuracy while at the same time keeping the computation complexity low.

In the explorative method, a fundamentally new number recognition concept was developed, hereinafter also referred to as ENI: Enhanced Number Identification, which requires only 21 subgrammatics, minimizes computer load and from a recognition point of view is clearly superior to existing methods.

The present invention provides a speech recognition method and system, which detects a number spoken in several different ways. For example numbers, such as “12” or “1000” can be spoken as any single-digit number in continuous sequence, for example “one-two” or “one-zero-zero-zero” or as a multi-digit number, such as “twelve” or “one thousand.”

More precisely, a method with the following steps is provided for attaining the above object: detecting and digitizing a spoken numeral, breaking down the numeral into number-related word components, determining the mutual positions of the word components within the numeral, comparing and recognizing the numerical values corresponding to the word components using word component number value pairs maintained in a digital dictionary, and stringing together and/or adding and/or multiplying the individual numerical values according to the type thereof and the positions of the corresponding word components in the numeral such that the numerical value corresponding to the input numeral is obtained.

With the help of the ENI number recognition system, according to the invention greater usage comfort with number detection is achieved because the user (speaker) no longer must enter larger numerals as individual digits, but can interact in natural language with the machine. A further advantage is that improved detection is achieved. Since the detection accuracy of a voice recognition system drops in line with the increase in grammar, ENI achieves significant improvement in the detection performance because only relatively compact grammar is required, which significantly reduces the required computing performance.

Unlike the existing grammar used for number detection, ENI does not analyze the statement according to the logic of the decimal system, but based on speech logic. The target value, meaning the number to be detected, is computed in part from the individual detected numerical values and/or in part combined (concatenated) from number symbols.

### DETAILED DESCRIPTION OF THE PREFERRED EMBODIMENTS

The present invention will be explained in more detailed based on exemplary embodiments.

Individual digits are formed from numerical values (NumCalcSection), and individual digits in number combinations are formed from numerical symbols (NumSymSection).

The symbols, which are characterized by quotation marks, cannot be used for computation purposes. They are linked to each other chain-like within the framework of a concatenation process (cat).

Example:

| | | |
|---|---|---|
| Two | −> {return (2)} | −> 2 |
| Two two | −> {return(cat(cat(cat(,,2”)“2”)“5”) | −> 225 |
| five | | |

Among two-digit numerical values, a differentiation is made between the ten range (Teen section), meaning the values “ten” to “nineteen,” and the two-digit range above that (Decimal section), meaning “twenty-one” to “ninety-nine.” Single-digit detection and decimal digit detection are combined here. The detected digits are then added within the Decimal section (add).

Example:

| | | |
|---|---|---|
| Seventeen | −> {return (“17”)} | −> 17 |
| Thirty_two | −> {return (add(30 2))} | −> 32 |

The hundred range is formed by the numerical value (NumCalcSection) in front of the word “hundred” multiplied with the numerical value “100” as well as an addition of the subsequent Teen section or Decimal section.

Example:

| Three_hundred_five | −> {return (add(mul(100 3)5))} |
|---|---|
| | −> 305 |
| Eight_hundred_sixteen | −> {return (add(mul(100 8)16))} |
| | −> 816 |
| Two_hundred_twenty_four | −> {return (add(add(mul(100 |
| | 2)4)20)}−> 224 |

The thousand range is opened up based on precisely this pattern with NumSym section in front of the word “thousand” or the Teen section in front of the word “hundred” and the subsequent hundred range from the symbol range. Here concatenation is used exclusively. If the thousand range is stated by a multiple of “hundred,” the Teen section in front of the word “hundred” is multiplied with the numerical value “100”.

Example:

| Three_thousand_four_hundred_twelve | −> {return | −> |
|---|---|---|
| | (cat(cat(cat(3 4)12)} | 3412 |
| Fourteen_hundred_and_eighteen | −> {return | −> |
| | (add(mul(14 100)18)} | 1418 |

The ten-thousand range is captured by the Teen section or Decimal section in front of the word “thousand” and the subsequent hundred range. Depending on their positions in the numeral, the numerical values are added or concatenated.

Example:

Fourteen_thousand_eight_hundred_twenty_three

−> {return (add(cat(cat(cat(14 8)3)20))} 14823.

The hundred-thousand range is formed based on precisely this pattern from the hundred range in front of the word “thousand” and the subsequent hundred range.

Example:

Nine_hundred_eight_thousand_and_twenty_three

−> (return (cat(cat(cat(cat(mul(10 9)8)0)2)3)} −> 908023.

The number “one million” is detected as a single numerical value.

The number-forming pattern described above comprises a small number of modules, which are linked based on speech logic rules. This pattern can be expanded upward without difficulty and is in a position to capture even much larger numbers, but this is hardly useful in ASR. Also numbers with commas in arbitrary length can be integrated and understood easily.

1-11. (canceled)

12. A method for the natural-language recognition of numbers for use in a voice recognition system, the method comprising:
detecting and digitizing a spoken numeral;
breaking down the numeral into number-related word components;
determining the mutual positions of the word components within the numeral;
comparing and recognizing the numerical values corresponding to the word components using word component number value pairs maintained in a digital dictionary; and
stringing together and/or adding and/or multiplying the individual numerical values according to the number of detected numerical values, the type thereof and the positions of the corresponding word components in the numeral such that the numerical value corresponding to the input numeral is obtained.

13. The method according to claim 12, wherein the word components “zero,” “one,” “two,” “three,” “four,” “five,” “six,” “seven,” “eight,” “nine,” “ten,” “eleven,” “twelve,” “thirteen,” “fourteen,” “fifteen,” “sixteen,” “seventeen,” “eighteen,” “nineteen,” “twenty,” “thirty,” “forty,” “fifty,” “sixty,” “seventy,” “eighty,” “ninety,” “hundred,” “one hundred,” “two hundred,” “three hundred,” “four hundred,” “five hundred,” “six hundred,” “seven hundred,” “eight hundred,” “nine hundred,” “thousand,” “million,” “one million,” are detected as word components and associated with the corresponding numerical values 0, 1, 2, . . . , 1000, 1000000.

14. The method according to claim 12, wherein the single-digit numbers are formed directly from the numerical values determined from a dictionary.

15. The method according to claim 13, wherein the single-digit numbers are formed directly from the numerical values determined from a dictionary.

16. The method according to claim 12, wherein a stringing together of several individual digits can be formed from the chain-like linking of the individual numerical values.

17. The method according to claim 13, wherein a stringing together of several individual digits can be formed from the chain-like linking of the individual numerical values.

18. The method according to claim 14, wherein a stringing together of several individual digits can be formed from the chain-like linking of the individual numerical values.

19. The method according to claim 12, wherein in the case of two-digit numbers a differentiation is made between a ten range (Teen section) and a two-digit number range above that (Decimal section), the digits in the ten range being formed directly from the numerical values associated with the detected word components and the digits in the decimal range by adding individual numerical values.

20. The method according to claim 13, wherein in the case of two-digit numbers a differentiation is made between a ten range (Teen section) and a two-digit number range above that (Decimal section), the digits in the ten range being formed directly from the numerical values associated with the detected word components and the digits in the decimal range by adding individual numerical values.

21. The method according to claim 14, wherein in the case of two-digit numbers a differentiation is made between a ten range (Teen section) and a two-digit number range above that (Decimal section), the digits in the ten range being formed directly from the numerical values associated with the detected word components and the digits in the decimal range by adding individual numerical values. at a 180° orientation with respect to the complementary slots in said valve member, to provide complementary slot shaping.

22. The method according to claim 12, wherein a digit in the hundred range is formed by multiplication of the numerical value captured in front of the word component “hundred” with the numerical value “100” and, if present, an addition of the numerical values formed according to claim 12.

23. The method according to claim 13, wherein a digit in the hundred range is formed by multiplication of the numerical value captured in front of the word component “hundred” with the numerical value “100” and, if present, an addition of the numerical values formed according to claim 12.

24. The method according to claim 13, wherein a digit in the hundred range is formed by multiplication of the numerical value captured in front of the word component “hundred” with the numerical value “100” and, if present, an addition of the numerical values formed according to claim 13.

25. The method according to claim 14, wherein a digit in the hundred range is formed by multiplication of the numerical value captured in front of the word component “hundred” with the numerical value “100” and, if present, an addition of the numerical values formed according to claim 12.

26. The method according to claim 14, wherein a digit in the hundred range is formed by multiplication of the numerical value captured in front of the word component “hundred” with the numerical value “100” and, if present, an addition of the numerical values formed according to claim 13.

27. The method according to claim 14, wherein a digit in the hundred range is formed by multiplication of the numerical value captured in front of the word component “hundred” with the numerical value “100” and, if present, an addition of the numerical values formed according to claim 14.

28. The method according to claim 14, wherein a digit in the hundred range is formed by multiplication of the numerical value captured in front of the word component “hundred” with the numerical value “100” and, if present, an addition of the numerical values formed according to claim 12.

29. The method according to claim 14, wherein a digit in the hundred range is formed by multiplication of the numerical value captured in front of the word component “hundred” with the numerical value “100” and, if present, an addition of the numerical values formed according to claim 13.

30. The method according to claim 14, wherein a digit in the hundred range is formed by multiplication of the numerical value captured in front of the word component “hundred” with the numerical value “100” and, if present, an addition of the numerical values formed according to claim 14.

31. The method according to claim 19, wherein a digit in the hundred range is formed by multiplication of the numerical value captured in front of the word component “hundred” with the numerical value “100” and, if present, an addition of the numerical values formed according to claim 12.

32. The method according to claim 19, wherein a digit in the hundred range is formed by multiplication of the numerical value captured in front of the word component “hundred” with the numerical value “100” and, if present, an addition of the numerical values formed according to claim 13.

33. The method according to claim 19, wherein a digit in the hundred range is formed by multiplication of the numerical value captured in front of the word component “hundred” with the numerical value “100” and, if present, an addition of the numerical values formed according to claim 14.

34. The method according to claim 19, wherein a digit in the hundred range is formed by multiplication of the numerical value captured in front of the word component “hundred” with the numerical value “100” and, if present, an addition of the numerical values formed according to claim 16.

35. The method according to claim 12, wherein a digit in the thousand range is formed by multiplication of the numerical value captured in front of the word component “thousand” with the numerical value “1000” and, if present, an addition of the numerical values formed according to claim 12.

36. The method according to claim 13, wherein a digit in the thousand range is formed by multiplication of the numerical value captured in front of the word component “thousand” with the numerical value “1000” and, if present, an addition of the numerical values formed according to claim 12.

37. The method according to claim 13, wherein a digit in the thousand range is formed by multiplication of the numerical value captured in front of the word component “thousand” with the numerical value “1000” and, if present, an addition of the numerical values formed according to claim 13.

38. The method according to claim 12, wherein a digit in the thousand range is formed by multiplication of the numerical value captured in front of the word component “hundred” with the numerical value “100” and, if present, an addition of the numerical values formed according to claim 12.

39. The method according to claim 13, wherein a digit in the thousand range is formed by multiplication of the numerical value captured in front of the word component “hundred” with the numerical value “100” and, if present, an addition of the numerical values formed according to claim 12.

40. The method according to claim 13, wherein a digit in the thousand range is formed by multiplication of the numerical value captured in front of the word component “hundred” with the numerical value “100” and, if present, an addition of the numerical values formed according to claim 13.

41. The method according to claim 12, wherein a digit in the ten-thousand range is formed by the Teen section or the Decimal section in front of the word component “thousand” and the subsequent hundred range.

42. The method according to claim 13, wherein a digit in the ten-thousand range is formed by the Teen section or the Decimal section in front of the word component “thousand” and the subsequent hundred range.

43. The method according to claim 12, wherein a digit in the hundred-thousand range is formed by the detected hundred range in front of the word component “thousand” and the subsequent hundred range.

44. The method according to claim 13, wherein a digit in the hundred-thousand range is formed by the detected hundred range in front of the word component “thousand” and the subsequent hundred range.

45. The method according to claim 12, wherein the word component “million” or “one million” is detected as an individual numeral.

46. The method according to claim 13, wherein the word component “million” or “one million” is detected as an individual numeral.
